(19) United States
(12) Patent Application Publication
(10) Pub. No.: US 2010/0200489 A1
(43) Pub. Date: Aug. 12, 2010

(54) Pressure Filter Type Water Kettle

(76) Inventor: Pinhung Peng, Toufen Township (TW)

Correspondence Address: JACKSON IPG PLLC, 106 Starvale Lane, Shipman, VA, 22971, US

(21) Appl. No.: 12/648,332

(22) Filed: Dec. 29, 2009

(30) Foreign Application Priority Data
Feb. 11, 2009 (TW) 098201928

(51) Int. Cl. B01D 25/19; B01D 25/164

(52) U.S. Cl. 210/229

(57) ABSTRACT

A pressure filter type water kettle includes a kettle body for holding water, a pressure device holder mounted in the kettle body to close the top open side of the kettle body, a filter fastened to the bottom side of the pressure device holder and dipped in water in the kettle body, and a pressure device mounted in the pressure device holder and operable to apply compressed air into the kettle body and to further force water through a series of filter layers in the filter so that water is filtered into a drinkable condition.

### BACKGROUND OF THE INVENTION

1. Field of the Invention

The present invention relates to water kettles and more particularly, to a pressure filter type water kettle, which is manually operable by a user to force water in the kettle body move through a series of filter layers so that filtered water can be drunk directly.

2. Description of the Related Art

There are filter kettles commercially available. These filter kettle have a simple filter device mounted therein for filtering water. However, this type of simple filter device does not provide a satisfactory filtering effect. Water filtered through this type of simple filter device remains acidic, not very good to human health. Further, regular drinking water is boiled water. However, boiling water for drinking consumes a big amount of gas or electricity. Consuming gas energy or electricity is not environmentally friendly.

### SUMMARY OF THE INVENTION

The present invention has been accomplished under the circumstances in view. It is one object of the present invention to provide a pressure filter type water kettle, which can be conveniently carried by a user for use at home, or in an outdoor activity such as mountain climbing, clinic or military operation, for treating city water or mountain water into drinkable water. It is another object of the present invention to provide a pressure filter type water kettle, which is practical for treating water into healthy drinking water without boiling, thereby helping energy-saving and carbon dioxide reduction.

To achieve these and other objects of the present invention, a pressure filter type water kettle comprises a kettle body for holding water, a pressure device holder mounted in the kettle body to close the top open side of the kettle body, a filter fastened to the bottom side of the pressure device holder and dipped in water in the kettle body, and a pressure device mounted in the pressure device holder and operable to apply compressed air into the kettle body and to further force water through a series of filter layers in the filter so that water is filtered into a drinkable condition.

### BRIEF DESCRIPTION OF THE DRAWING

FIG. 1 is a perspective view of a pressure filter type water kettle in accordance with the present invention.

FIG. 2 is an exploded view of the pressure filter type water kettle in accordance with the present invention.

FIG. 3 is an exploded view of the pressure device holder, pressure device and filter of the pressure filter type water kettle in accordance with the present invention.

FIG. 4 is an elevational assembly view of FIG. 3.

FIG. 5 is a sectional plain view in an enlarged scale of the pressure filter type water kettle in accordance with the present invention.

FIG. 6 is a perspective view of the present invention after separation of the pressure device from the pressure device holder.

### DETAILED DESCRIPTION OF THE INVENTION

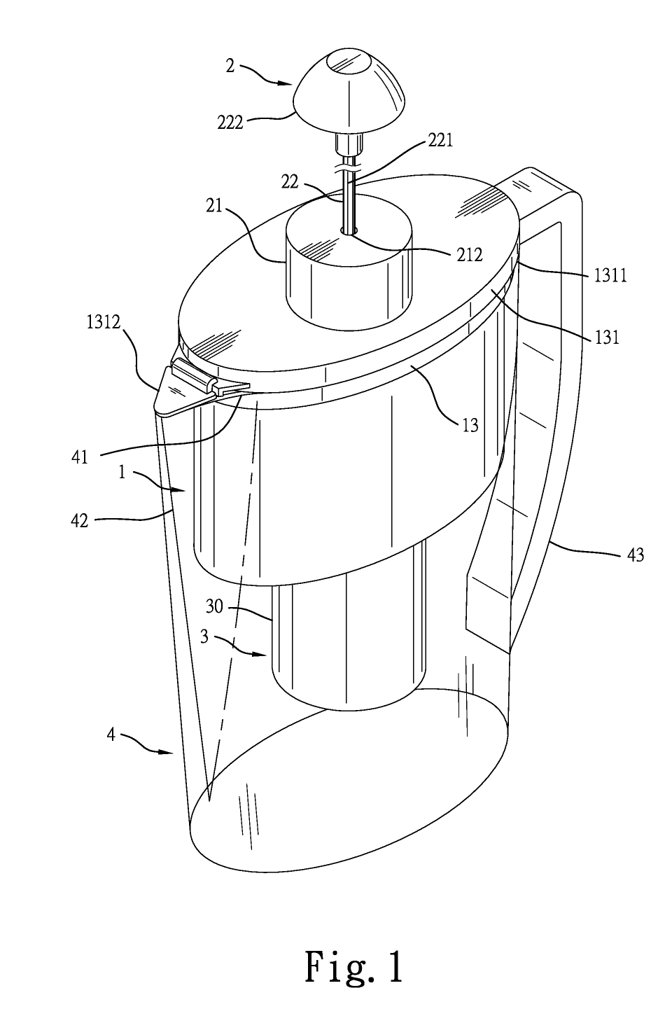

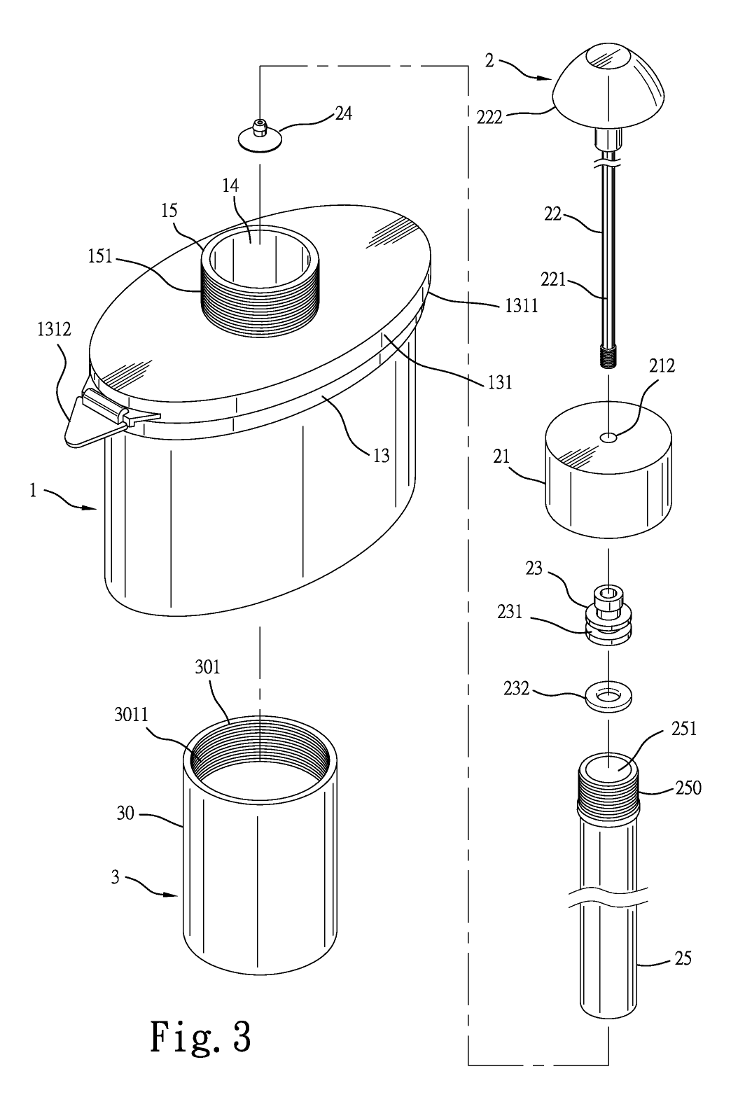

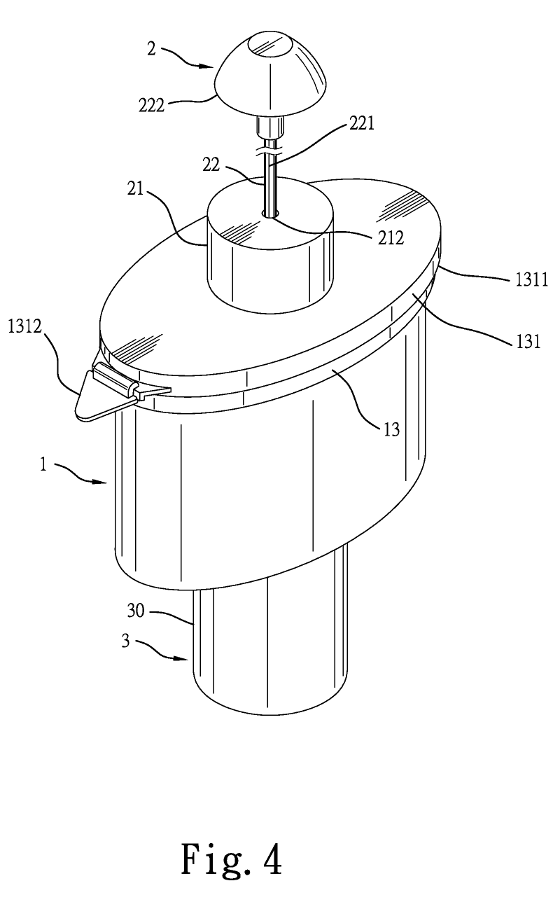

Referring to FIGS. 1-6, a pressure filter type water kettle in accordance with the present invention is shown comprising a pressure device holder 1, a pressure device 2, a filter 3, and a kettle body 4.

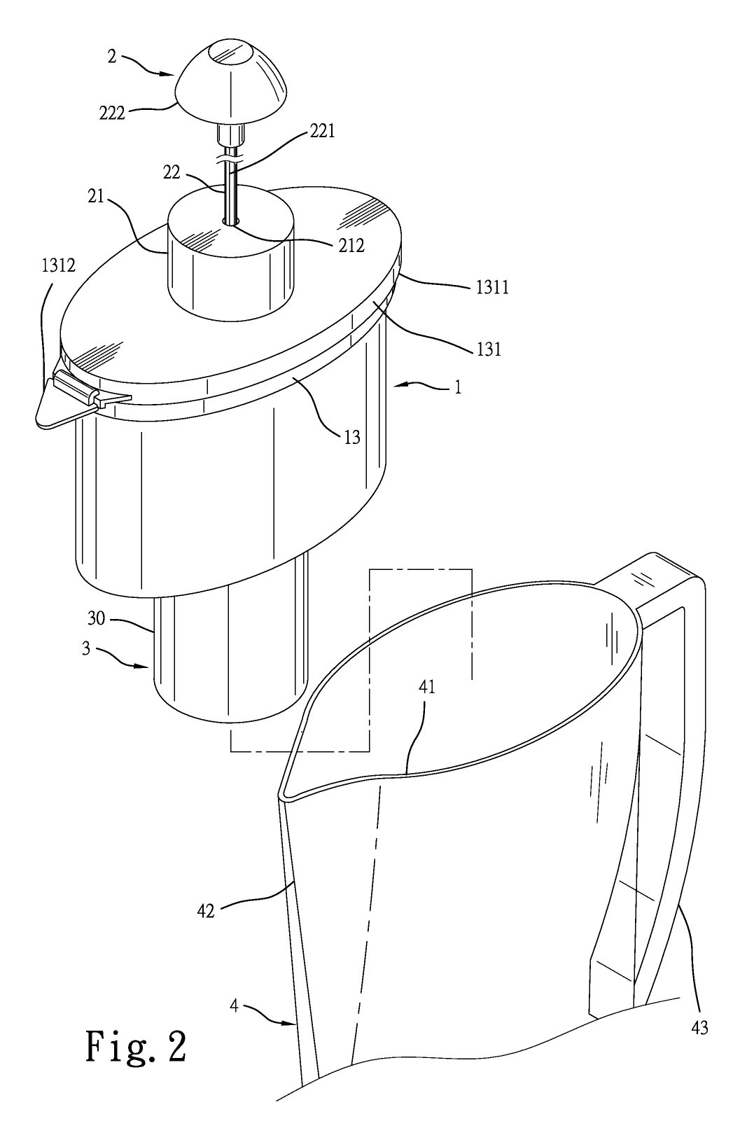

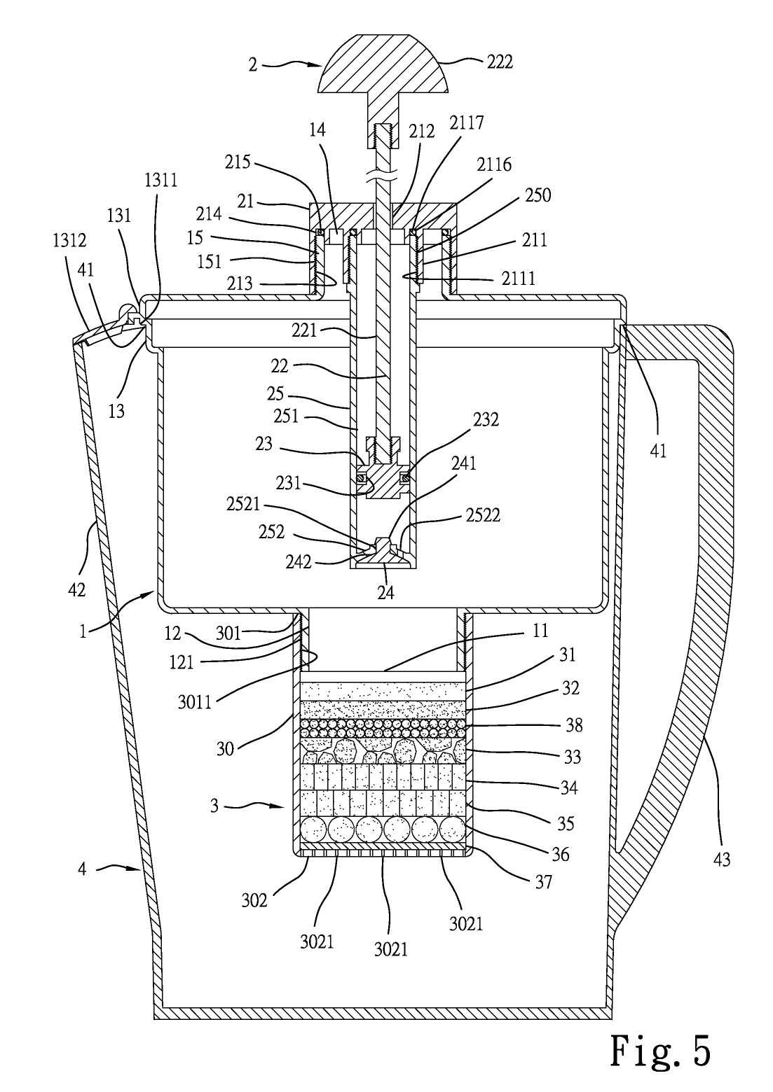

The pressure device holder 1 is a hollow shell inserted into the kettle body 2, having an engagement portion 13 that is press-fitted into the top open side of the kettle body 4, a stop flange 131 that is stopped with its bottom wall 1311 at the topmost edge of the kettle body 4 after insertion of the pressure device holder 1 into the kettle body 4 (see FIGS. 2 and 5), a tubular bottom coupling flange 12 downwardly extending from the bottom wall thereof and defining a bottom opening 11 for the connection of the filter 3 (see FIG. 5), and a tubular top neck 15 defining a top opening 14 for the mounting of the pressure device 2.

The pressure device 2 comprises a cap 21, a piston rod 22, a piston 23, a valve flap 24, and a cylinder 25. The cap 21 is fastened to the top neck 15 of the pressure device holder 1 by means of a screw joint or any other connection method, having a tubular connection portion 211 (see FIG. 5) axially downwardly extended from the inner top wall thereof at the center for connection to the top end of the cylinder 25, an axial hole 212 cut through the top and bottom sides thereof for the passing of the rod body 221 of the piston rod 22. The piston rod 22 has a handle 222 fixedly connected to one end, namely, the top end of the rod body 221. The other end, namely, the bottom end of the rod body 221 is inserted through the axial hole 212 of the cap 21 and fixedly connected with the piston 23. The piston 23 has an annular groove 231 extending around the periphery for the mounting of a sealing ring 232. After connection of the piston 23 to the bottom end of the rod body 221 of the piston rod 22, the piston 23 is inserted with the sealing ring 232 and the rod body 221 into the inside of the cylinder chamber 251 of the cylinder 25. The cylinder 25 has a bottom wall 252 (see FIG. 5), a locating hole 2521 located on the bottom wall 252, and an exhaust hole 2522 cut through the bottom wall 252. The valve flap 24 has a top mounting portion 241 fastened to the locating hole 2521. Normally, the top wall 242 of the valve flap 24 is kept in close contact with the bottom wall 252 of the cylinder 25 to close the exhaust hole 2522.

The filter 3 comprises a hollow filter body 30 and multiple filter layers 31˜38 arranged inside the hollow filter body 30 at different elevations (see FIG. 5). The hollow filter body 30 has a top opening 301 connected to the tubular bottom coupling flange 12 of the pressure device holder 1, a bottom wall 302, and a plurality of through holes 3021 cut through the bottom wall 302 (see FIG. 5). The filter layers 31˜38 include, from the top side toward the bottom side, a ceramic membrane filter layer 31, a heavy metal chelating agent-added bamboo charcoal filter layer 32, a fine-grained ion-exchange resin filter layer 38, a grained copper-zinc alloy kinetic degradation fluxion (KDF) filter layer 33, a grained calcium sulfite filter layer 34, a grained alkali trace element filter layer 35, an power stone filter layer 36 and a silver ion-loaded nonwoven fabric filter layer 37.

The kettle body 4 is a top-open water container, having a handle 43 protruded from the periphery at one side, a rim 41 for supporting bottom wall 1311 of the stop flange 131 of the pressure device holder 1, and a spout 41 for pouring water out of the kettle body 4. According to the present preferred embodiment, the kettle body 4 is made of a transparent material.

Further, the tubular top neck 15 of the pressure device holder 1 has an outer thread 151 extending around the periphery, and the cap 21 of the pressure device 2 has an inner thread 213 extending around the inside wall thereof and threaded onto the outer thread 151 of the tubular top neck 15 of the pressure device holder 1 (see FIG. 5). Further, the cap 21 has an inside annular groove 214 and a sealing ring 215 mounted in the inside annular groove 214 and stopped against the topmost edge of the tubular top neck 15 of the pressure device holder 1 to seal the gap.

Further, the tubular bottom coupling flange 12 of the pressure device holder 1 has an outer thread 121 extending around the periphery, and the filter body 30 has an inner thread 3011 extending around the inside wall in the top opening 301 and threaded onto the outer thread 121 of the tubular bottom coupling flange 12 of the pressure device holder 1.

Further, the tubular connection portion 211 of the cap 21 of the pressure device 2 has an inner thread 2111 extending around the inside wall, and the cylinder 25 has an outer thread 250 extending around the periphery of the top end and threaded into the inner thread 2111 of the tubular connection portion 211 of the cap 21. Further, the cap 21 has an inside annular groove 2116 located inside the tubular connection portion 211, and a sealing ring 2117 mounted in the inside annular groove 2116 and stopped against the topmost edge of the cylinder 25 to seal the gap.

Further, a sealing ring (not shown) may be mounted in between the tubular bottom coupling flange 12 of the pressure device holder 1 and the top end of the filter body 30 of the filter 3 to seal the gap.

Further, the valve flap 24 of the pressure device 2 can be molded from flexible rubber or plastics.

Further, as shown in FIG. 5, the pressure device holder 1 has a lid 1312 pivotally connected to the stop flange 131 for closing the spout 42 of the kettle body 4.

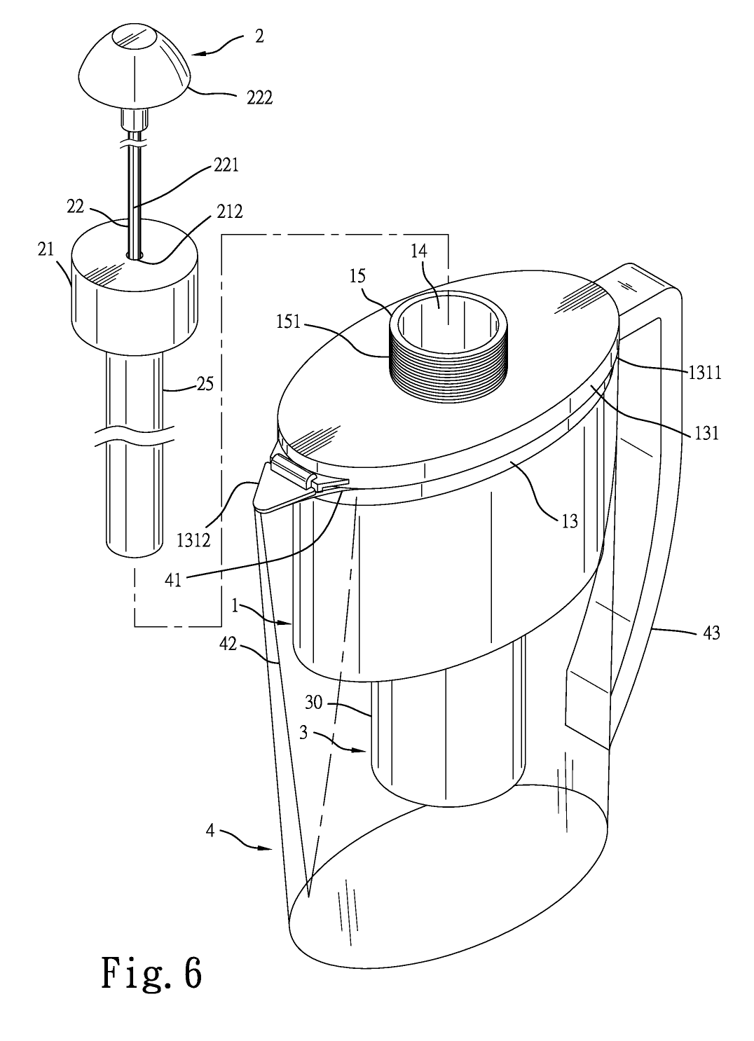

When using the pressure filter type water kettle, loosen the cap 21 of the pressure device 2 from the tubular top neck 15 of the pressure device holder 1 and then remove the pressure device 2 from the pressure device holder 1 (see FIG. 6), and then pour water through the top opening 14 of the tubular top neck 15 of the pressure device holder 1 into the filter 3 and then the inside of the kettle body 4. Thereafter, fasten the cap 21 of the pressure device 2 to the tubular top neck 15 of the pressure device holder 1 to have the pressure device 2 be held in the pressure device holder 1 (see FIGS. 1 and 5), and then hold the handle 222 of the piston rod 22 of the pressure device 2 with one hand and reciprocate the piston rod 22 to pump air through the exhaust hole 2522 of the cylinder 25. During downward stroke of the piston rod 22, compressed air is forced into the exhaust hole 2522 to force the valve flap 24 apart from the bottom wall 252 of the cylinder 25 so that compressed air enter the filter 3. At this time, the water in the water container 4 is forced by the compressed air to flow through the ceramic membrane filter layer 31, the heavy metal chelating agent-added bamboo charcoal filter layer 32, the fine-grained ion-exchange resin filter layer 38, the grained copper-zinc alloy kinetic degradation fluxion (KDF) filter layer 33, the grained calcium sulfite filter layer 34, the grained alkali trace element filter layer 35, the power stone filter layer 36 and the silver ion-loaded nonwoven fabric filter layer 37, and therefore impurities, germs and heavy metal substances are removed from water. The ceramic membrane filter layer 31 is made of silver ion-loaded diatomite through a sintering process, having filter apertures about 0.5 μm that remove germs, bacteria and other microbes effectively. The microbes filtering efficiency of the ceramic membrane filter layer 31 is as high as 99.99% up. When the water flows through the heavy metal chelating agent-added bamboo charcoal filter layer 32 that is made of compressed bamboo charcoal and added with a heavy metal chelating agent, chloroform, toxic chemical substances, volatile organic compounds (Vocs), iron rust, bad smell, heavy metals and pesticide are removed from the water. When the water flows through the fine-grained ion-exchange resin filter layer 38, the fine-grained ion-exchange resin filter layer 38 absorbs lime from the water so that the water is changed from hard water into soft water. When the water flows through the grained copper-zinc alloy kinetic degradation fluxion (KDF) filter layer 33, the grained copper-zinc alloy kinetic degradation fluxion (KDF) filter layer 33 regulates the Ph value of the water, lowering the concentration of calcium and magnesium ions in the water, prohibition growth of germs and fungi, and removing water soluble heavy metals, such as lead, iron, cadmium, aluminum, and other inorganic substances. When the water flows through the grained calcium sulfite filter layer 34, the heat-resistant 98% high purity calcium sulfite effectively removes chloride from the water. When the water flows through the grained alkali trace element filter layer 35 that is prepared from deep-sea minerals and volcano rocks and minerals through a biochemical technology recombination and sintering process effectively converts the water into alkaline ionic water. When the water flows through the power stone filter layer 36, the power stone filter layer 36 cuts the clusters of the water molecules of sizes from 13˜16 molecules into sizes of 5˜6 molecules, enhancing water activity so that filtered water can effectively carry pollutants away from the human body cells, animal cells, or plant cells. Further, the power stone of the power stone filter layer 36 emits far infrared rays, and is prepared from a tourmaline powder and clay mixture through a sintering process. When the water flows through the silver ion-loaded nonwoven fabric filter layer 37, the active silver ions of the silver ion-loaded nonwoven fabric filter layer 37 rapidly bind the sulfur-hydrogen groups of the enzyme protein in bacteria, causing the enzyme to lose its activity. Therefore, the silver ion-loaded nonwoven fabric filter layer 37 effectively kills bacteria, such as E. coli, staphylococcus aureus bacteria, salmonella enterica and pseudomonas aeruginosa. Further, the silver ion-loaded nonwoven fabric filter layer 37 is non-toxic and free from the effects of acids and alkalis, does not cause any drug resistance or allergic effect.

In general, the pressure filter type water kettle of the present invention has the following advantages: 1. By means of operating the pressure device 2, water in the kettle body 4 is forced to permeate through the filter layers 31˜38. Thus, water in the kettle body 4 is well filtered for drinking.

2. The pressure filter type water kettle is convenient for use at home, in office, or at any place to filter city water or mountain water into a drinking condition.

3. The use of the pressure filter type water kettle is environment friendly. Because filtered water is drinkable, no further boiling is necessary. Therefore, the invention helps energy-saving and carbon dioxide reduction.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A pressure filter type water kettle, comprising:
a kettle body for holding water, said kettle body comprising a rim around a top opening thereof;
a pressure device holder being a hollow shell, said pressure device holder comprising an engagement portion press-fitted into the top opening of said kettle body, a stop flange stopped at the rim of said kettle body, a tubular bottom coupling flange downwardly extending from a bottom wall thereof and defining a bottom opening, and a tubular top neck defining a top opening in communication with said bottom opening;
a pressure device, said pressure device comprising a cap, a piston rod, a piston, a valve flap and a cylinder, said cap being fastened to the top neck of said pressure device holder, said cap comprising a tubular connection portion downwardly extended from an inner top wall thereof and connected to said cylinder and an axial hole cut through top and bottom sides thereof for the passing of said piston rod, said piston rod comprising a rod body inserted through the axial hole of said cap and a handle fixedly connected to a top end of said rod body, said piston being fixedly connected to a bottom end of said rod body and having an annular groove extending around the periphery thereof and a sealing ring mounted in the annular groove, said piston being inserted with said rod body into the inside of said cylinder, said cylinder comprising a locating hole and an exhaust hole located on a bottom wall thereof, said valve flap comprising a top mounting portion fastened to the locating hole of said cylinder such that said valve flap being movable to close and open said exhaust hole of said cylinder; and
a filter, said filter comprising a hollow filter body and multiple filter layers arranged inside said hollow filter body at different elevations, said hollow filter body comprising a top opening connected to the tubular bottom coupling flange of said pressure device holder and a plurality of through holes cut through a bottom wall, said filter layers comprising, from a top side toward a bottom side, a ceramic membrane filter layer, a heavy metal chelating agent-added bamboo charcoal filter layer, a fine-grained ion-exchange resin filter layer, a grained copper-zinc alloy kinetic degradation fluxion (KDF) filter layer, a grained calcium sulfite filter layer, a grained alkali trace element filter layer, an power stone filter layer and a silver ion-loaded nonwoven fabric filter layer.

2. The pressure filter type water kettle as claimed in claim 1, wherein the tubular top neck of said pressure device holder and the cap of said pressure device are fastened together through a screw joint.

3. The pressure filter type water kettle as claimed in claim 2, wherein said cap comprises an inside annular groove and a sealing ring mounted in the inside annular groove and stopped against the topmost edge of the tubular top neck of said pressure device holder.

4. The pressure filter type water kettle as claimed in claim 1, wherein the tubular bottom coupling flange of said pressure device holder and the top opening of said filter body of said filter are fastened together through a screw joint.

5. The pressure filter type water kettle as claimed in claim 4, further comprising a sealing ring that seals the gap between the tubular bottom coupling flange of said pressure device holder and the top opening of said filter body of said filter.

6. The pressure filter type water kettle as claimed in claim 1, wherein said cap and said cylinder are fastened together through a screw joint.

7. The pressure filter type water kettle as claimed in claim 6, wherein said cap comprises a sealing ring mounted in an inside annular groove thereof and stopped against the topmost edge of said cylinder.

8. The pressure filter type water kettle as claimed in claim 1, wherein said valve flap of said pressure device is molded from one of a material group of flexible rubber and flexible plastics.

9. The pressure filter type water kettle as claimed in claim 1, wherein said ceramic membrane filter layer is made of silver ion-loaded diatomite through a sintering process.

10. The pressure filter type water kettle as claimed in claim 1, wherein said heavy metal chelating agent-added bamboo charcoal filter layer is made of compressed bamboo charcoal and added with a heavy metal chelating agent.

11. The pressure filter type water kettle as claimed in claim 1, wherein said grained alkali trace element filter layer is prepared from natural minerals through a sintering process.

12. The pressure filter type water kettle as claimed in claim 1, wherein said power stone filter layer emits far infrared rays, and is prepared from a tourmaline powder and clay mixture through a sintering process.

13. The pressure filter type water kettle as claimed in claim 1, wherein said kettle body comprises a spout for pouring water out of said kettle body.

14. The pressure filter type water kettle as claimed in claim 1, wherein said kettle body comprises a handle protruded from the periphery thereof at one lateral side.
